(19) United States
(12) Patent Application Publication
(10) Pub. No.: US 2018/0097432 A1
(43) Pub. Date: Apr. 5, 2018

(54) POWER GENERATOR

(71) Applicant: Chiung-Hao CHEN, Tainan City (TW)

(72) Inventors: Chiung-Hao CHEN, Tainan City (TW); Hsin-Hung LIU, Tainan City (TW)

(21) Appl. No.: 15/692,621

(22) Filed: Aug. 31, 2017

(30) Foreign Application Priority Data
Oct. 4, 2016 (TW) 105215038

(51) Int. Cl. H02K 21/24

(52) U.S. Cl. CPC H02K 21/24; H02K 1/2793

(57) ABSTRACT

A power generator includes a supporting frame mechanism, a magnetic plate unit, a wire tray unit and a transmission mechanism. The transmission mechanism includes two axial member units extending along an axis, rotatably mounted to the supporting frame mechanism, and coaxial with each other, and a plurality of transmission shafts extending through the magnetic plate unit and the wire tray unit, angularly spaced apart from each other, rotatably disposed about the axis, and driven by the axial member units to drive relative rotation between the wire tray unit and the magnetic plate unit.

### CROSS-REFERENCE TO RELATED APPLICATION

This application claims priority of Taiwanese Patent Application No. 105215038, filed on 4 Oct. 2016.

### FIELD

The disclosure relates to a power generator, and more particularly to a disc type power generator.

### BACKGROUND

Disc type power generator is one kind of developing power generators, which has high energy transforming efficiency. Electric power generated by the disc type power generator not only can be offered for operating the disc type power generator, but also can be stored for other usage.

A conventional disc type power generator includes a supporting frame, a plurality of wire trays and magnetic plates alternately mounted to the supporting frame, and a transmission shaft coaxially extending through the wire trays and the magnetic plates to drive relative rotations between the wire trays and the magnetic plates to generate the electric power.

Since each of the wire trays and the magnetic plates has a certain weight, connecting portions between the wire trays and the transmission shaft, and between the magnetic plates and the transmission shaft are subjected to relatively large torque, and are thus easy to be broken, and the wire trays and the magnetic plates are required to be often replaced.

### SUMMARY

Therefore, the object of the disclosure is to provide a power generator that can alleviate at least one of the drawbacks of the prior art.

According to the disclosure, the power generator includes a supporting frame mechanism, a magnetic plate unit, a wire tray unit and a transmission mechanism. The magnetic plate unit includes at least one magnetic plate module including a plurality of magnets that are angularly spaced apart from each other. The wire tray unit generates electric power induced by a relative rotation between the wire tray unit and the magnets of the magnetic plate unit. The transmission mechanism includes two axial member units extending along an axis, rotatably mounted to the supporting frame mechanism, and coaxial with each other, and a plurality of transmission shafts mounted between the axial member units, extending through the at least one magnetic plate module of the magnetic plate unit and the wire tray unit, and rotatable about the axis. The transmission shafts are angularly spaced apart from each other, are disposed about the axis, and are driven by the axial member units to drive the relative rotation between the wire tray unit and the at least one magnetic plate module of the magnetic plate unit.

### BRIEF DESCRIPTION OF THE DRAWINGS

Other features and advantages of the disclosure will become apparent in the following detailed description of the embodiment with reference to the accompanying drawings, of which:

FIG. 1 is a perspective view of an embodiment of a power generator according to the disclosure;

FIG. 2 is a partly exploded perspective view of the embodiment;

FIG. 3 is a fragmentary partly exploded perspective view of the embodiment;

FIG. 4 is aside sectional view of the embodiment; and

FIG. 5 is a top sectional view of the embodiment.

### DETAILED DESCRIPTION

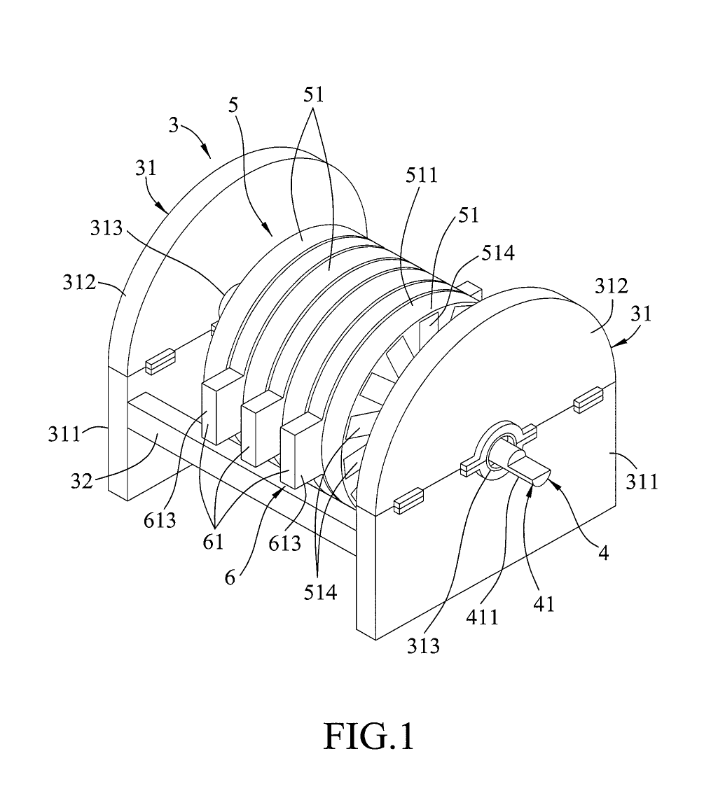

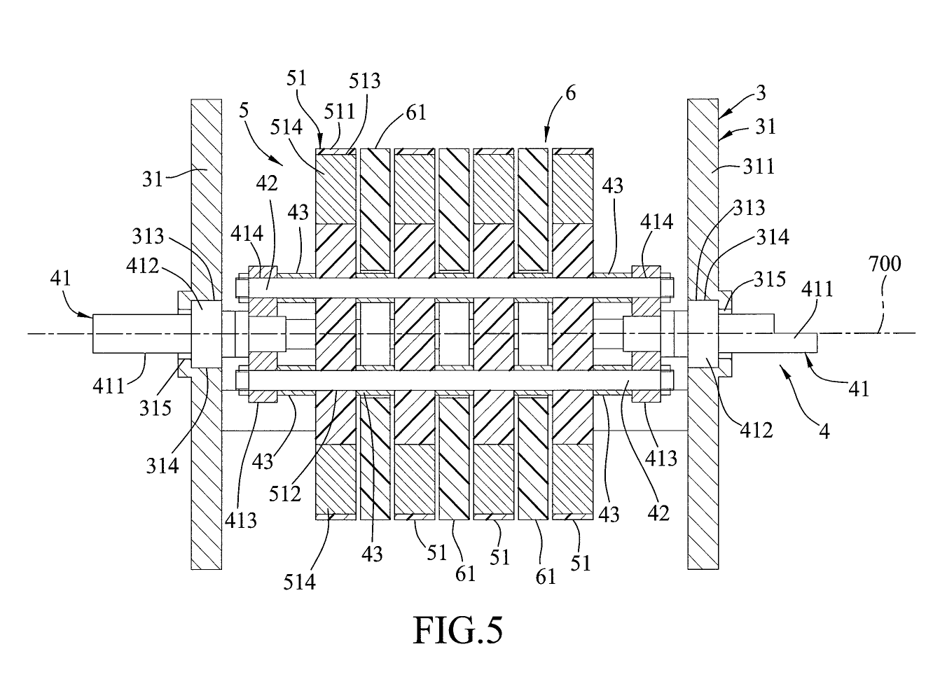

Referring to FIGS. 1, 2 and 5, the embodiment of a power generator according to the disclosure is adapted to be connected to a motor mechanism (not shown), is adapted to be electrically connected to a power storage equipment (not shown) , is adapted to be driven by the motor mechanism to generate electric power, and deliver the electric power to the power storage equipment. The power generator includes a supporting frame mechanism 3, a transmission mechanism 4 mounted to the supporting frame mechanism 3, a magnetic plate unit 5 mounted to the transmission mechanism 4, and a wire tray unit 6 mounted to the supporting frame mechanism 3.

The supporting frame mechanism 3 includes two spaced apart mounting wall units 31, and two spaced apart frame rods 32 fixedly connected between the mounting wal 1 units 31. Each of the mounting wall units 31 has a base wall 311, and a top wall 312 removably mounted on and above the base wall 311, and cooperating with the base wall 311 to define a supporting hole 313 therebetween. The supporting hole 313 extending along an axis 700. The frame rods 32 extend in a direction parallel to the axis 700, and are respectively located at two sides of the axis 700. The supporting hole 313 of one of the mounting wall units 31 has a first section 314 proximate to the other one of the mounting wall units 31, and a second section 315 distal from the other one of the mounting wall units 31, and having a diameter that is smaller than that of the first section 314.

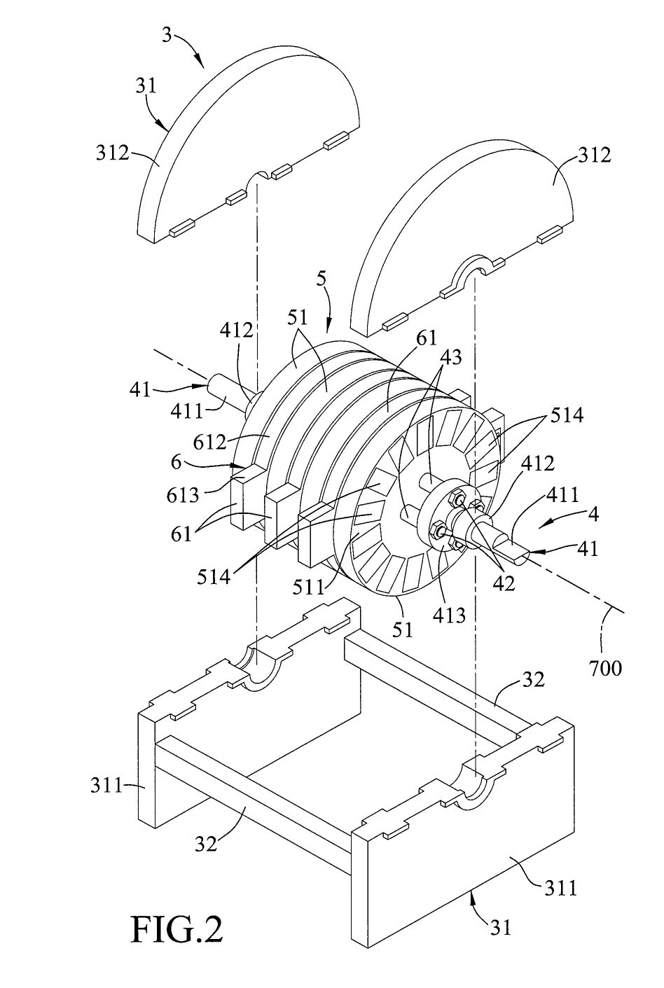

Referring to FIGS. 2, 3 and 5, the transmission mechanism 4 includes two axial member units 41 extending along the axis 700, respectively and rotatably mounted to the mounting wall units 31 of the supporting frame mechanism 3, and coaxial with each other, a plurality of transmission shafts 42 mounted between the axial member units 41, and rotatable about the axis 700, and a plurality of spacers 43 sleeved onto the transmission shafts 42. The transmission shafts 42 are angularly spaced apart from each other, are disposed about the axis 700, and are driven by the axial member units 41 to drive a relative rotation between the wire tray unit 6 and the magnetic plate unit 5.

Each of the axial member units 41 is confined between the base wall 311 and the top wall 312 of a corresponding one of the mounting wall units 31, and includes a side rod 411 extending through the supporting hole 313 of the corresponding one of the mounting wall units 31 along the axis 700, a bearing 412 sleeved onto the side rod 411, and mounted inside the first section 314 of the corresponding one of the supporting holes 313 of the supporting frame mechanism 3, and a transmission plate 413 coaxially and fixedly connected to one end of the side rod 411 that is located between the mounting wall units 31. Each of the transmission plates 413 has a plurality of coupling holes 414 angularly spaced apart from each other, and disposed about the axis 700.

Each of the transmission shafts 42 is fixedly connected between the transmission plates 413 of the axial member units 41, and extends through corresponding two coupling holes 414 such that, the transmission shafts 42 are co-rotatable with the axial member units 41. Each of the transmission shafts 42 is sleeved with two of the spacers 43 that are spaced apart from each other, and that are driven by a corresponding one of the transmission shafts 42 to rotate about the axis 700.

The magnetic plate unit 5 includes at least one magnetic plate module 51. The transmission shafts 42 extend through the at least one magnetic plate module 51, such that the transmission shafts 42 are co-rotatable with the at least one magnetic plate module 51 about the axis 700. In this embodiment, the magnetic plate unit 5 includes a plurality of magnetic plate modules 51 spaced apart from each other along the axis 700. Each of the magnetic plate modules 51 is disposed between two adjacent spacers 43. It should be noted that, the number of the magnetic plate modules 51 may be varied in other embodiments. Each of the spacers 43 is disposed for spacing a corresponding one of the transmission plates 413 from an adjacent one of the magnetic plate modules 51. Each of the magnetic plate modules 51 has a plate body 511, and includes a plurality of magnets 514 angularly spaced apart from each other, embedded into and exposed from the plate body 511 in directions parallel to the axis 700, and co-rotatable with the plate body 511 about the axis 700. Each of the plate bodies 511 of the magnetic plate modules 51 abuts against two adjacent spacers 43 such that, relative axial movements between the transmission shafts 42 and the plate bodies 511 of the magnetic plate modules 51 are prevented.

Each of the plate bodies 511 has a plurality of through holes 512 angularly spaced apart from each other, disposed about the axis 700, and permitting the transmission shafts 42 to respectively extend therethrough, and a plurality of mounting holes 513 respectively disposed for embedding the magnets 514 of a corresponding one of the magnetic plate modules 51.

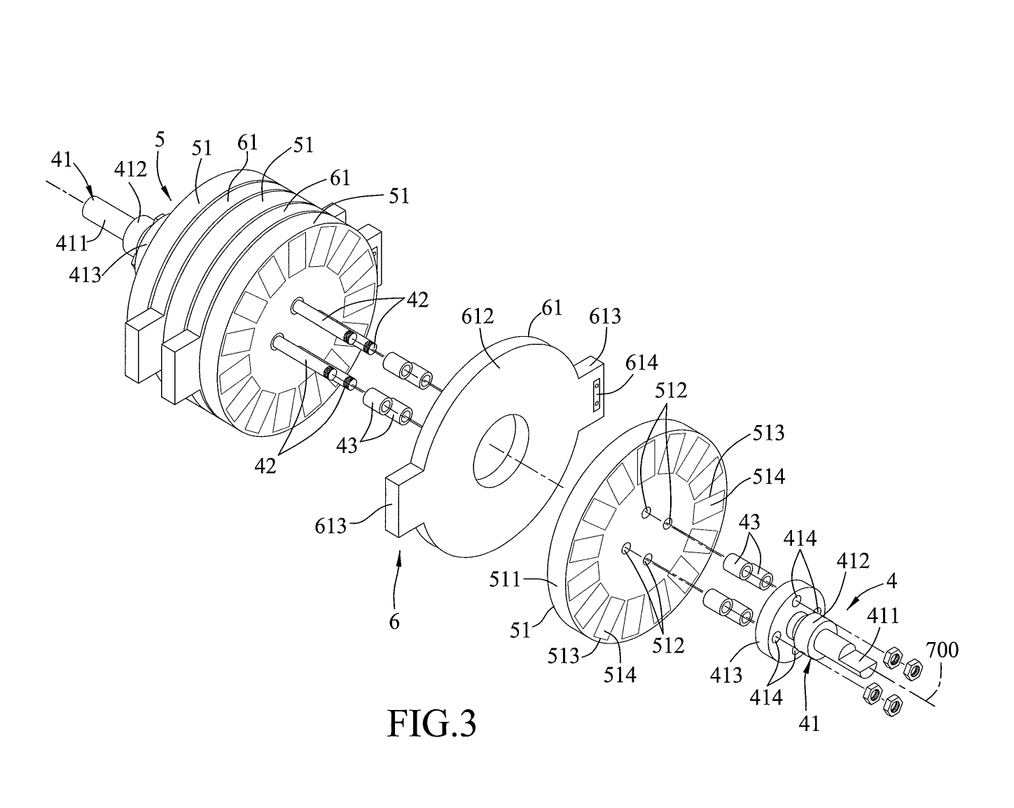

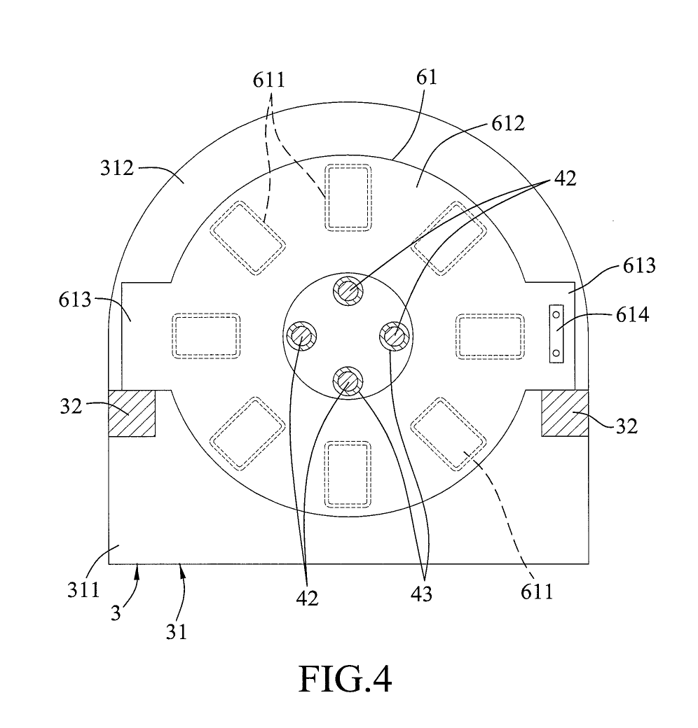

Referring to FIGS. 3 to 5, the wire tray unit 6 generates the electric power that is induced by the relative rotation between the wire tray unit 6 and the magnets 514 of the magnetic plate unit 5, and includes at least two wire tray modules 61 mounted onto the supporting frame mechanism 3, surrounding and spaced apart from the transmission shafts 42, and spaced apart from each other along the axis 700. In this embodiment, the wire tray unit 6 includes three wire tray modules 61, and the number of the wire tray modules 61 may be varied in other embodiments. The wire tray modules 61 and the magnetic plate modules 51 are alternatively disposed along the axis 700. Each of the wire tray modules 61 has at least one coil 611 disposed for generating the electric power; an annular cover body 612 covering the at least one coil 611, surrounding and spaced apart from the transmission shafts 42, and disposed between the frame rods 32; two wing portions 613 radially and respectively protruding from two sides of the cover body 612 away from each other, and respectively mounted onto and above the frame rods 32; and an output terminal 614 electrically connected to the at least one coil 611, and embedded in and exposed from one of the wing portions 613. The cover bodies 612 of the wire tray modules 61 are spaced apart from the spacers 43, such that the spacers 43 can co-rotate with the transmission shafts 42 about the axis 700 without contacting the cover bodies 612.

In this embodiment, each of the wire tray modules 61 has a plurality of coils 611 angularly spaced apart from each other about the axis 700. The output terminal 614 of each of the wire tray modules 61 aggregates the electric power generated by the coils 611. As the disposition and the connecting methods of the coils 611 are plenty, and not the focus of the disclosure improved, so are not further described herein.

Referring back to FIGS. 2, 3 and 5, during operation, the side rod 411 of one of the axial member units 41 is connected to the motor mechanism, such that the motor mechanism drives operation of the power generator. Since the axial member units 41 are connected to the transmission shafts 42, and the transmission shafts 42 extend through the magnetic plate modules 51, the axial member units 41 and the transmission shafts 42 co-rotate with the magnetic plate modules 51. The magnets 514 of each of the magnetic plate modules 51 are driven by the plate body 511 of a corresponding one of the magnetic plate modules 51 to rotate relative to adjacent two of the wire tray modules 61 such that, the adjacent two of the wire tray modules 61 generate the electric power induced by the relative rotation between the magnets 514 of the corresponding one of the magnetic plate modules 51 and the adjacent two of the wire tray modules 61. Subsequently, the electric power is delivered from the output terminal 614 to the power storage equipment.

In conclusion, since the magnetic plate modules 51 are driven by the transmission shafts 42, stress generated between a transmission shaft and magnetic plates of a conventional disc type power generator is dispersed, and transmission power is largely increased, such that the magnetic plate modules 51 with a larger size can be applied. In addition, since the wire tray modules 61 are mounted onto the supporting frame mechanism 3 without contacting with the transmission shafts 42 and the spacers 43, disposition of the bearings 412 between the wire tray modules 61 and the transmission shafts 42 is not required, and the disposition of the wire tray modules 61 onto the supporting frame mechanism 3 is much more steady.

In the description above, for the purposes of explanation, numerous specific details have been set forth in order to provide a thorough understanding of the embodiment. It will be apparent, however, to one skilled in the art, that one or more other embodiments maybe practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A power generator comprising:
a supporting frame mechanism;
a magnetic plate unit including at least one magnetic plate module that includes a plurality of magnets angularly spaced apart from each other;
a wire tray unit generating electric power that is induced by a relative rotation between said wire tray unit and said magnets of said magnetic plate unit; and
a transmission mechanism including two axial member units that extend along an axis, that are rotatably mounted to said supporting frame mechanism, and that are coaxial with each other, and a plurality of transmission shafts that are mounted between said axial member units, that extend through said at least one magnetic plate module of said magnetic plate unit and said wire tray unit, and that are rotatable about the axis,
said transmission shafts being angularly spaced apart from each other and disposed about the axis, and being driven by said axial member units to drive the relative rotation between said wire tray unit and said at least one magnetic plate module of said magnetic plate unit.

2. The power generator as claimed in claim 1, wherein:
each of said axial member units includes a side rod extending along the axis, a bearing sleeved onto said side rod, and mounted inside said supporting frame mechanism, and a transmission plate fixedly connected to said side rod; and
each of said transmission shafts is fixedly connected between said transmission plates of said axial member units.

3. The power generator as claimed in claim 2, wherein:
said supporting frame mechanism includes two spaced apart mounting wall units respectively disposed for mounting said axial member units; and
each of said mounting wall units has a base wall, and a top wall removably mounted on and above said base wall, and cooperating with said base wall to define a supporting hole therebetween which is disposed for mounting a corresponding one of said bearings of said axial member units therein.

4. The power generator as claimed in claim 1, wherein:
said wire tray unit surrounds and is spaced apart from said transmission shafts, and is mounted onto said supporting frame mechanism;
said at least one magnetic plate module has a plate body;
said transmission shafts extend through said plate body of said at least one magnetic plate module, such that said transmission shafts are co-rotatable with said plate body of said at least one magnetic plate module about the axis; and
said magnets are embedded into said plate body along the axis, and are co-rotatable with said plate body relative to said wire tray unit.

5. The power generator as claimed in claim 4, wherein:
said wire tray unit includes two annular wire tray modules mounted onto said supporting frame mechanism, surrounding and spaced apart from said transmission shafts, and respectively disposed at two opposite sides of said at least one magnetic plate module along the axis; and
said wire tray modules generate the electric power induced by the relative rotation between said wire tray modules and said magnets of said magnetic plate unit.

6. The power generator as claimed in claim 4, wherein:
said wire tray unit includes a plurality of annular wire tray modules mounted onto said supporting frame mechanism, surrounding and spaced apart from said transmission shafts, and spaced apart from each other along the axis;
said magnetic plate unit includes a plurality of magnetic plate modules, said transmission shafts extending through said magnetic plate modules;
said wire tray modules and said magnetic plate modules are alternatively disposed along the axis; and
said magnets of each of said magnetic plate modules are driven by said plate body of a corresponding one of said magnetic plate modules to rotate relative to adjacent two of said wire tray modules such that, said adjacent two of said wire tray modules generate the electric power induced by the relative rotation between said magnets of the corresponding one of said magnetic plate modules and said adjacent two of said wire tray modules.

7. The power generator as claimed in claim 6, wherein said transmission mechanism further includes a plurality of spacers sleeved onto said transmission shafts, and each disposed for spacing a corresponding one of said transmission plates from an adjacent one of said magnetic plate modules.

8. The power generator as claimed in claim 6, wherein each of said plate bodies of said magnetic plate modules has a plurality of mounting holes respectively disposed for embedding said magnets of a corresponding one of said magnetic plate modules, and a plurality of through holes angularly spaced apart from each other, disposed about the axis, and permitting said transmission shafts to respectively extend therethrough.

9. The power generator as claimed in claim 6, wherein each of said wire tray modules has at least one coil disposed for generating the electric power, an annular cover body covering said at least one coil, and surrounding and spaced apart from said transmission shafts, and two wing portions radially and respectively protruding from two sides of said cover body away from each other, and mounted onto said supporting frame mechanism.

10. The power generator as claimed in claim 9, wherein:
said supporting frame mechanism has two spaced apart mounting wall units respectively disposed for mounting said axial member units, and two spaced apart frame rods extending in a direction parallel to the axis, respectively located at two sides of the axis, and fixedly connected between said mounting wall units; and
said cover body of each of said wire tray modules is disposed between said frame rods, said wing portions of each of said wire tray modules being respectively mounted onto and above said frame rods.
